(19) United States
(12) Patent Application Publication
(10) Pub. No.: US 2026/0310409 A1
(43) Pub. Date: Oct. 8, 2026

(54) CONTROL METHOD AND DEVICE FOR APPROXIMATE ADDER CIRCUIT BASED ON MEMRISTOR

(71) Applicant: HUAZHONG UNIVERSITY OF SCIENCE AND TECHNOLOGY, Hubei (CN)

(72) Inventors: Xingsheng Wang, Hubei (CN); Zhouchao Gan, Hubei (CN); Mengjie Li, Hubei (CN); Xiangshui Miao, Hubei (CN)

(73) Assignee: HUAZHONG UNIVERSITY OF SCIENCE AND TECHNOLOGY, Hubei (CN)

(21) Appl. No.: 19/394,797

(22) Filed: Nov. 19, 2025

(30) Foreign Application Priority Data
Mar. 26, 2025 (CN) 202510361286.4

(51) Int. Cl. G06F 7/544

(52) U.S. Cl. CPC G06F 7/544; G06F 2207/4814

(57) ABSTRACT

Disclosed are a control method for an approximate adder circuit based on memristor and an approximate adder device. The approximate adder circuit includes only 2n+1 memristors and one resistor. The present disclosure divides the approximate addition process of two n-bit numbers into initialization and n rounds of approximate addition sub-processes, and makes each round of the approximate addition sub-process execute a 1-bit approximate addition operation. In each round of the approximate addition sub-process, corresponding first, second, and third memristors are selected, only three steps of operations are required: setting the state of the first and second memristors and applying a voltage to each memristor and the resistor to implement the 1-bit approximate addition operation, so that the actual operation steps required for the entire approximate addition are only 2n+1 steps.

### CROSS-REFERENCE TO RELATED APPLICATION

This application claims the priority benefit of China application serial no. 202510361286.4, filed on Mar. 26, 2025. The entirety of the above-mentioned patent application is hereby incorporated by reference herein and made a part of this specification.

### BACKGROUND

### Technical Field

The present disclosure is related to microelectronic devices, and more specifically, relates to a control method for an approximate adder circuit based on memristor and an approximate adder device.

### Description of Related Art

With the rapid development of artificial intelligence and big data technologies, high-performance computing imposes higher requirements on the energy efficiency and performance of hardware systems. Due to the separation of storage and computation units, conventional von Neumann architecture encounters issues such as the “memory wall” and “power wall” caused by frequent data transfers, which dramatically limits the improvement of computational efficiency. By performing computational operations directly within the storage units, in-memory computing technology significantly reduces the latency and energy consumption associated with data transmission, thus becoming a crucial direction for research to overcome the bottlenecks of conventional computing architectures. As a novel type of non-volatile memory, memristors exhibit great potential for application due to its characteristics of high density, low power consumption, and compatibility with CMOS processes. Memristors may not only be used for data storage but also realize logic computation functions through their resistive switching properties.

Approximate adders, as a design capable of optimizing performance under the premise of tolerating some computational errors, are widely used in image processing, artificial intelligence, signal processing and so on. The core concept of approximate adders is to sacrifice a portion of precision in order to reduce power consumption, shorten computational delay, and minimize chip area by simplifying the circuit structure. Particularly in image processing tasks such as edge detection, image compression, and filtering operations, the requirements for computational precision are relatively low. Therefore, approximate adders may achieve efficient data processing with reduced resource consumption.

The design of approximate adders based on memristor offers a novel hardware solution by integrating the advantages of in-memory computing with the flexibility of approximate computing. However, existing approximate adders based on memristor are implemented based on IMPLY logic, which, despite yielding relatively simple Boolean logic expressions, sacrifices considerable computational accuracy. Consequently, the computational accuracy of the proposed approximation algorithms requires further enhancement. Additionally, due to the inefficient logic synthesis capability of IMPLY logic, the number of devices required and the operational steps involved are significantly high.

### SUMMARY

In view of the defects or needs for improvement of the existing technology, the present disclosure provides a control method for an approximate adder circuit based on memristor and an approximate adder device, aiming to address the technical problem in the related art of achieving approximate addition operations with high computational accuracy while using fewer components and operational steps.

To achieve the above purpose, in a first aspect, the present disclosure provides a control method for an approximate adder circuit based on memristor for implementing approximate addition of n-bit numbers aₙ . . . a₂a₁ and bₙ . . . b₂b₁. The approximate adder circuit includes: a resistor and 2n+1 identical memristors; negative electrodes of respective memristors are all connected to the same source line SL; one end of the source line SL is floating, and the other end is connected to one end of the resistor; n≥1.

The above control method includes:

Selecting n memristors from the 2n+1 memristors, and writing logic values a₁~aₙ respectively; selecting one memristor from the remaining memristors, and writing aₙ input carry c₁; setting all other unset memristors to a high resistance state;

Executing n rounds of approximate addition sub-processes sequentially;

In an i-th round of the approximate addition sub-process, the following operations are executed:

In a first time period, a memristor written with a logic value aᵢ is used as a first memristor, and a voltage −V is applied to a positive electrode thereof. A memristor storing the carry cᵢ is used as a second memristor, and a positive electrode thereof is set to float. One memristor among the unset memristors is selected as a third memristor, a voltage V_{P} is applied to a positive electrode thereof, and a voltage with aₙ amplitude 0 is applied to the other end of the resistor. Under the circumstances, carry cᵢ₊₁=aᵢ·bᵢ is obtained from the third memristor.

In a second time period after the first time period, a voltage V−V_{P} is applied to the positive electrode of the first memristor. The voltage V_{P} is applied to the positive electrode of the second memristor. The positive electrode of the third memristor is set to float. The voltage −V is applied to the other end of the resistor. Under the circumstances, a sum result sᵢ=aᵢ⊕bᵢ+cᵢ is obtained from the second memristor.

Wherein, i=1, 2, . . . , n, when a logic value bᵢ is 0, the value of V is 0; when the logic value bᵢ is 1, the value of V is V_{P}; V_{P} satisfies Vₛₑₜ/2<V_{P}<Vₛₑₜ, and V_{P}<2|Vᵣₑₛₑₜ|; Vₛₑₜ is a threshold for the memristor to convert from a high resistance state to a low resistance state; Vᵣₑₛₑₜ is a threshold for the memristor to convert from the low resistance state to the high resistance state;

sₙ . . . s₂s₁ and cₙ₊₁ are the approximate addition result of the required n-bit numbers aₙ . . . a₂a₁ and bₙ . . . b₂b₁.

In a second aspect, the present disclosure provides aₙ approximate adder device for implementing approximate addition of n-bit numbers aₙ . . . a₂a₁ and bₙ . . . b₂b₁, including: an approximate adder circuit and a control module.

The approximate adder circuit includes: a resistor and 2n+1 identical memristors. Negative electrodes of respective memristors are all connected to the same source line SL. One end of the source line SL is floating, and the other end is connected to one end of the resistor; n≥1.

The control module is configured to execute the control method provided by the first aspect of the present disclosure.

Further preferably, a resistance value of the resistor is between a high resistance state resistance value and a low resistance state resistance value of the memristor.

Further preferably, a resistance value of the resistor is R=\sqrt{R_{H}·R_{L}}, wherein, R_{H} is the high resistance state resistance value of the memristor, R_{L} is the low resistance state resistance value of the memristor.

Further preferably, the memristors all include the high resistance state and the low resistance state. The high resistance state corresponds to a logic value “0”, and the low resistance state corresponds to a logic value “1”.

In a third aspect, the present disclosure provides a control system, including: a memory and a processor. The memory stores a computer program, and the processor executes the control method provided in the first aspect of the present disclosure when executing the computer program.

In a fourth aspect, the present disclosure also provides a computer-readable storage medium. The computer-readable storage medium includes a stored computer program, wherein, when the computer program is run by a processor, the computer program controls the device where the storage medium is located to execute the control method provided in the first aspect of the present disclosure.

In a fifth aspect, the disclosure also provides a computer program product, including a computer program/instructions. When the computer program/instructions are executed by a processor, the control method provided in the first aspect of the present disclosure is implemented.

Overall, through the above technical solutions conceived by the present disclosure, the following advantageous effects may be achieved:

1. The first aspect of the present disclosure provides a control method for aₙ approximate adder circuit based on memristor for implementing approximate addition of two n-bit numbers aₙ . . . a₂a₁ and bₙ . . . b₂b₁, thus obtaining a sum result sₙ . . . s₂s₁ and a carry output cₙ₊₁. The controlled approximate adder circuit only includes 2n+1 memristors and one resistor, divides the n-bit approximate addition process into initialization and n rounds of approximate addition sub-processes, and makes each round of the approximate addition sub-process execute aₙ 1-bit approximate addition operation. In each round of the approximate addition sub-process, the first memristor, the second memristor and the third memristor are selected. The logic value aᵢ is defined as the resistance state of the first memristor. The logic value cᵢ is defined as the resistance state of the second memristor. The logic value bᵢ is defined in the form of voltage at a voltage input terminal of the first memristor and the source line SL. The resistance states of the second memristor and the third memristor serve as outputs. Only three steps of operations are required to set the states of the first memristor and the second memristor and apply the voltage to the memristors and the resistor to implement the 1-bit approximate addition operation, so that the actual operation steps required for the entire approximate adder circuit to execute are only 2n+1 steps. For the 1-bit approximate addition operation, calculation errors only occur in two input situations, with relatively small approximate errors. Compared with existing n-bit approximate adders, the present disclosure may implement approximate addition operations with a higher calculation accuracy under the condition of using fewer devices and operation steps.

2. The second aspect of the present disclosure provides aₙ approximate adder device, including: aₙ approximate adder circuit and a control module. The approximate adder circuit only includes 2n+1 memristors and one resistor. The control module controls the approximate adder circuit through the control method provided in the first aspect of the present disclosure, so as to implement approximate addition of two n-bit numbers aₙ . . . a₂a₁ and bₙ . . . b₂b₁. In this way, it is possible to significantly improve the calculation accuracy of approximate addition operations while reducing the number of devices and operation steps. In the meantime, the present disclosure also achieves low complexity and a small area circuit layout with a simple structure, and has significant advantages in high-density integrated applications.

3. The approximate adder device provided in the present disclosure fully utilizes the non-volatile characteristics of memristors. After the approximate addition operation is completed, the result is directly stored in the memristors, eliminating additional data transmission and storage steps, and significantly optimizing energy consumption performance and reducing operation delay.

4. Furthermore, in the approximate adder device provided by the present disclosure, the resistance value of the resistor is R=\sqrt{R_{H}·R_{L}}, so as to better distinguish the low resistance state, the high resistance state of the memristor and the resistance value of the resistor, thus further improving the reliability of calculation.

### BRIEF DESCRIPTION OF THE DRAWINGS

FIG. 1 is a structural schematic diagram of a 1-bit approximate adder device provided in Embodiment 1 of the present disclosure.

FIG. 2 is a structural schematic diagram of an n-bit approximate adder device provided in Embodiment 2 of the present disclosure.

FIG. 3 is a structural schematic diagram of a 4-bit serial approximate adder device provided in Embodiment 2 of the present disclosure.

### DESCRIPTION OF THE EMBODIMENTS

In order to make the purposes, technical solutions and advantages of the present disclosure more comprehensible, the present disclosure will be further described in detail below in combination with the accompanying drawings and embodiments. It should be understood that the specific embodiments described herein are only used to explain the present disclosure and are not used to limit the present disclosure. In addition, the technical features involved in the various embodiments of the present disclosure described below may be combined with each other as long as they do not conflict with each other.

In order to achieve the above purposes, in a first aspect, the present disclosure provides a control method for aₙ approximate adder circuit based on memristor for implementing approximate addition of n-bit numbers aₙ . . . a₂a₁ and bₙ . . . b₂b₁. The approximate adder circuit includes: a resistor and 2n+1 identical memristors. Negative electrodes of respective memristors are all connected to the same source line SL. One end of the source line SL is floating, and the other end is connected to one end of the resistor; n≥1.

The above control method includes:
Selecting n memristors from the 2n+1 memristors, and writing logic values a₁~aₙ respectively; selecting one memristor from the remaining memristors, and writing aₙ input carry c₁; setting all other unset memristors to a high resistance state;
Executing n rounds of approximate addition sub-processes sequentially;
In aₙ i-th round of the approximate addition sub-process, the following operations are executed:

In a first time period, a memristor written with a logic value aᵢ is used as a first memristor, and a voltage −V is applied to a positive electrode thereof. A memristor storing the carry cᵢ is used as a second memristor, and a positive electrode thereof is set to float. One memristor among the unset memristors is selected as a third memristor, a voltage V_{P} is applied to a positive electrode thereof, and a voltage with aₙ amplitude 0 is applied to the other end of the resistor. Under the circumstances, carry cᵢ₊₁=aᵢ·bᵢ is obtained from the third memristor.

In a second time period after the first time period, a voltage V−V_{P} is applied to the positive electrode of the first memristor. The voltage V_{P} is applied to the positive electrode of the second memristor. The positive electrode of the third memristor is set to float. The voltage −V is applied to the other end of the resistor. Under the circumstances, a sum result sᵢ=aᵢ⊕bᵢ+cᵢ is obtained from the second memristor.

Wherein, i=1, 2, . . . , n, when a logic value bᵢ is 0, the value of V is 0; when the logic value bᵢ is 1, the value of V is V_{P}; V_{P} satisfies Vₛₑₜ/2<V_{P}<Vₛₑₜ, and V_{P}<2|Vᵣₑₛₑₜ|; Vₛₑₜ is a threshold for the memristor to convert from a high resistance state to a low resistance state; Vᵣₑₛₑₜ is a threshold for the memristor to convert from the low resistance state to the high resistance state;

sₙ . . . s₂s₁ and cₙ₊₁ are the approximate addition result of the required n-bit numbers aₙ . . . a₂a₁ and bₙ . . . b₂b₁.

In a second aspect, the present disclosure provides aₙ approximate adder device for implementing approximate addition of n-bit numbers aₙ . . . a₂a₁ and bₙ . . . b₂b₁, including: aₙ approximate adder circuit and a control module.

The approximate adder circuit includes: a resistor and 2n+1 identical memristors. Negative electrodes of respective memristors are all connected to the same source line SL. One end of the source line SL is floating, and the other end is connected to one end of the resistor; n≥1.

The control module is configured to execute the control method provided by the first aspect of the present disclosure.

In aₙ optional implementation, a resistance value of the resistor is between the high resistance state resistance value and the low resistance state resistance value of the memristor. Preferably, the resistance value of the resistor is R=\sqrt{R_{H}·R_{L}}, wherein, R_{H} is the high resistance state resistance value of the memristor, R_{L} is the low resistance state resistance value of the memristor.

In an optional implementation, the memristors all include the high resistance state and the low resistance state. The high resistance state corresponds to a logic value “0”, and the low resistance state corresponds to a logic value “1”.

Related technical solutions are the same as the control method provided in the first aspect of the present disclosure, which will not be elaborated here.

In a third aspect, the present disclosure provides a control system, including: a memory and a processor. The memory stores a computer program, and the processor executes the control method provided in the first aspect of the present disclosure when executing the computer program.

Related technical solutions are the same as the control method provided in the first aspect of the present disclosure, which will not be elaborated here.

In a fourth aspect, the present disclosure also provides a computer-readable storage medium. The computer-readable storage medium includes a stored computer program, wherein, when the computer program is run by a processor, the computer program controls the device where the storage medium is located to execute the control method provided in the first aspect of the present disclosure.

Related technical solutions are the same as the control method provided in the first aspect of the present disclosure, which will not be elaborated here.

In a fifth aspect, the disclosure also provides a computer program product, including a computer program/instructions. When the computer program/instructions are executed by a processor, the control method provided in the first aspect of the present disclosure is implemented.

Related technical solutions are the same as the control method provided by the first aspect of the present disclosure, which will not be elaborated here.

To further illustrate the control method for the approximate adder circuit based on memristor and the corresponding approximate adder device provided in the present disclosure, detailed description will be given below in combination with specific embodiments.

### Embodiment 1

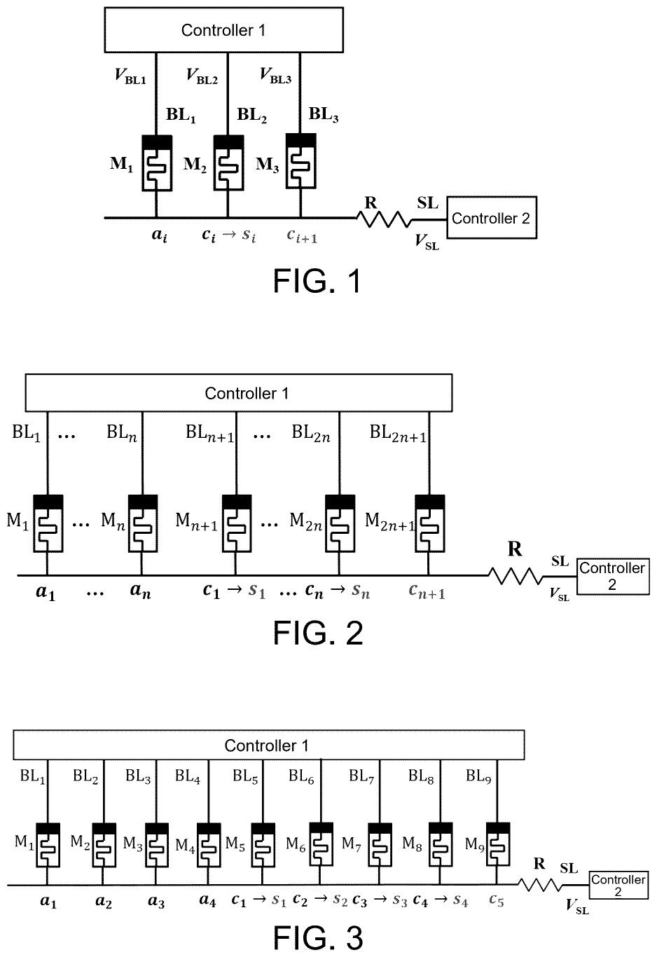

In this embodiment, a value of n is 1, and a 1-bit approximate adder device for performing approximate addition based on input logic values cᵢ, aᵢ, bᵢ (implementing approximate addition of the logic value aᵢ, the logic value bᵢ and aₙ input carry cᵢ) is provided, as shown in FIG. 1, including: an approximate adder circuit and a control module. The approximate adder circuit includes: a memristor M₁, a memristor M₂, a memristor M₃, and a resistor (a fixed-value resistor is adopted in this embodiment). An initial state of the memristor M₃ is a high resistance state. The control module includes: a controller 1 and a controller 2.

The controller 1 is respectively connected to positive electrodes of the memristor M₁, the memristor M₂ and the memristor M₃. Negative electrodes of the memristor M₁, the memristor M₂ and the memristor M₃ are all connected to the same source line SL. One end of the source line SL is floating, and the other end is connected to the controller 2. The resistor is connected to the source line SL, with one end connected to a control terminal of the source line SL, and the other end connected to the negative electrode of the memristor closest to the source line control terminal.

The controller 1 includes a control terminal BL₁, a control terminal BL₂, and a control terminal BL₃. The control terminal BL₁ is connected to the positive electrode of the memristor M₁, the control terminal BL₂ is connected to the positive electrode of the memristor M₂, and the control terminal BL₃ is connected to the positive electrode of the memristor M₃. When the controller 1 performs an approximate addition operation, a voltage V_{BL1}, a voltage V_{BL2} and a voltage V_{BL3} that change with time are applied to the memristor M₁, the memristor M₂ and the memristor M₃ respectively through the control terminal BL₁, the control terminal BL₂ and the control terminal BL₃. When the controller 2 performs the approximate addition operation, a voltage VSL that changes with time is applied to the source line SL. It should be noted that the memristor M₁, the memristor M₂ and the memristor M₃ are completely identical, all of them include a high resistance state and a low resistance state, with the high resistance state corresponding to a logic value “0” and the low resistance state corresponding to a logic value “1”.

The controller 1 is configured to set the memristor M₁ to a resistance state corresponding to a logic value aᵢ, set the memristor M₂ to a resistance state corresponding to a logic value cᵢ, and set the memristor M₃ to the high resistance state before performing the approximate addition operation. When performing the approximate addition operation, the voltage V_{BL1}, the voltage V_{BL2} and the voltage V_{BL3} are applied to the memristor M₁, the memristor M₂ and the memristor M₃ respectively.

The controller 2 maintains grounded before performing the approximate addition operation. When performing the approximate addition operation, the voltage V_{SL} is applied to the source line SL.

The values of input voltages at respective control terminals are determined by the logic value bᵢ. Specifically, the approximate addition calculation process includes a first time period and a second time period after the first time period. The voltages that change with time are embodied in different values in the first time period and the second time period respectively. In the first time period, the value of the voltage V_{BL1} is −V, the control terminal BL₂ is floating; the value of the voltage V_{BL3} is V_{P}, and the value of the voltage V_{SL} is 0. In the second time period, the value of the voltage V_{BL1} is V−V_{P}, the value of the voltage V_{BL2} is V_{P}, the control terminal BL₃ is floating, and the value of the voltage V_{SL} is −V. When the logic value bᵢ is 0, the value of V is 0. When the logic value bᵢ is 1, the value of V is V_{P}.

Since the electrical signals used in the process of performing approximate addition are all voltage pulse signals, in order to ensure that memristors originally in the high resistance state will not change to the low resistance state when no operation is performed, also, when a voltage drop of 2V_{P} is applied across the memristor, to ensure that the memristor undergoes a resistance state change, an amplitude of the voltage V_{P} should be between Vₛₑₜ/2 and Vₛₑₜ. In addition, in order to ensure that memristors originally in the low resistance state will not change to the high resistance state when no operation is performed, it is also required to satisfy V_{P}<2|Vᵣₑₛₑₜ|. In view of the foregoing, V_{P} needs to satisfy Vₛₑₜ/2<V_{P}<Vₛₑₜ, and V_{P}<2|Vᵣₑₛₑₜ|. Vₛₑₜ is a threshold for the memristor to convert from the high resistance state to the low resistance state. Vᵣₑₛₑₜ is a threshold for the memristor to convert from the low resistance state to the high resistance state.

Furthermore, in order to make the low resistance state, the high resistance state and the resistance values of the memristor clearly distinguishable, the memristors with a switching ratio greater than or equal to a preset switching threshold are adopted. In this embodiment, a value of a preset switching threshold is 100. The resistance value of the resistor is between the high resistance state resistance value and the low resistance state resistance value of the memristor. Since the high resistance state and the value of low resistance state of the memristor are in different orders of magnitude, in order to further clearly distinguish the low resistance state, the value of high resistance state of the memristor and the resistance value of the resistor, preferably, the value of the resistance value of the resistor is R=\sqrt{R_{H}·R_{L}}, wherein R_{H} is the high resistance state resistance value of the memristor, and R_{L} is the low resistance state resistance value of the memristor. The fixed-value resistor mainly serves to limit currents in the logic circuit. Furthermore, considering that both the high resistance state and the low resistance state of the memristor fluctuate within a specific range, the selection of the resistance value R may be slightly larger than the result of \sqrt{R_{H}·R_{L}}, thus better ensuring the reliability of the circuit.

Specifically, the control method for the approximate adder circuit in the above 1-bit approximate adder device is configured to implement approximate addition of the logic value aᵢ, the logic value bᵢ and the input carry cᵢ, thus obtaining the sum result sᵢ and the carry output cᵢ₊₁, including the following steps:
S1. Setting the memristor M₁ to the resistance state corresponding to the logic value aᵢ, setting the memristor M₂ to the resistance state corresponding to the logic value cᵢ, setting the memristor M₃ to aₙ initial state high resistance state thereof,
S2. When performing approximate addition, in the first time period, applying the voltage V_{BL1_1}=−V to the memristor M₁, setting the control terminal BL₂ to float, applying the voltage V_{BL3_1}=V_{P} to the memristor M₃, and applying the voltage V_{SL_1}=0 to the source line; under the circumstances, the carry cᵢ₊₁=aᵢ·bᵢ is obtained from the third memristor;
S3. In the second time period, applying the voltage V_{BL1_2}=V−V_{P} to the memristor M₁, applying the voltage V_{BL2_2}=V_{P} to the memristor M₂, setting the control terminal BL₃ to float, and applying the voltage V_{SL_2}=−V to the source line; under the circumstances, the sum result sᵢ=aᵢ⊕bᵢ+cᵢ is obtained from the second memristor;

Wherein, when the logic value bᵢ is 0, the value of V is 0; when the logic value bᵢ is 1, the value of V is V_{P}; V_{P} satisfies Vₛₑₜ/2<V_{P}<Vₛₑₜ, and V_{P}<2|Vᵣₑₛₑₜ|; Vₛₑₜ is the threshold for the memristor to convert from the high resistance state to the low resistance state; Vᵣₑₛₑₜ is the threshold for the memristor to convert from the low resistance state to the high resistance state.

It should be noted that the control method for the 1-bit approximate adder device provided by this embodiment only includes 3 actual operation steps. As shown in Table 1, Table 1 shows the voltage configuration in each actual operation step under different logic inputs. Specifically, since the initial state of the memristor is the high resistance state when initially used, there is no need to perform the operation of setting the memristor M₃ to the high resistance state. Therefore, S1 only includes the operations of setting the memristor M₁ to the resistance state corresponding to the logic value aᵢ and setting the memristor M₂ to the resistance state corresponding to the logic value cᵢ, which corresponds to step 1 in Table 1. S2 and S3 implement the 1-bit approximate addition function by applying corresponding voltages, which corresponds to step 2 and step 3 in Table 1.

TABLE 1

| Step | Operation | BL₁ | BL₂ | BL₃ | SL |
|---|---|---|---|---|---|
| 1 | Writing aᵢ and cᵢ into the memristor M₁ and the memristor M₂ respectively, and initializing | | | | |
| | the memristor M₃ to the high resistance state | | | | |
| 2 | M₃: cᵢ₊₁ = aᵢ · bᵢ | −V | Floating | Vₚ | 0 |
| | | $\{ \begin{matrix}0 ( {b}_{i} = 0 ) \\ - {V}_{p} ( {b}_{i} = 1 )\end{matrix} ;$ | | | |
| 3 | M₂: sᵢ = aᵢ ⊕ bᵢ + cᵢ | V − Vₚ | Vₚ | Floating | −V |
| | | $\{ \begin{matrix}- {V}_{p} ( {b}_{i} = 0 ) \\ 0 ( {b}_{i} = 1 )\end{matrix} ;$ | | | $\{ \begin{matrix}0 ( {b}_{i} = 0 ) \\ - {V}_{p} ( {b}_{i} = 1 )\end{matrix} ;$ |

To make the technical solution and advantages of this embodiment clearer, this embodiment provides the resistance change conditions measured in actual circuits for eight input cases of the 1-bit approximate adder. In this embodiment, the value of the resistor R is 10 kΩ, and the switching ratio of the memristor is greater than or equal to 100, so that the resistance values of the memristor and the fixed-value resistor R at the low resistance state and the high resistance state may be clearly distinguished.

It should be noted that the two outputs of an exact full adder are respectively expressed as sᵢ=aᵢ⊕bᵢ⊕c_{I} and cᵢ₊₁=aᵢ·bᵢ+(aᵢ⊕bᵢ)·c_{I}; while the present disclosure improves the computation speed of approximate addition while maintaining accuracy by simplifying the carry generation process. The proposed approximate addition scheme may be expressed as sᵢ=aᵢ⊕bᵢ+c_{I} and cᵢ₊₁=aᵢ·bᵢ.

As shown in Table 2, Table 2 shows aₙ operation truth table of the 1-bit approximate adder. It can be seen from Table 2 that compared with the exact adder, the present disclosure only has calculation errors in two input cases. The specific operations and memristor states are as follows:

The initialization state of the memristor M₃ is the high resistance state.

When input aᵢ=0, bᵢ=0, cᵢ=0, V=0, the memristor M₁ is set to the high resistance state, and the memristor M₂ is set to the high resistance state. In step 2, a voltage V_{M1} across the memristor M₁ is approximately 0, a voltage V_{M2} across the memristor M₂ is approximately 0, and a voltage V_{M3} across the memristor M₃ is approximately V_{P}. The memristor M₂ maintains the high resistance state, and the memristor M₃ maintains the high resistance state. In step 3, the voltage V_{M1} across the memristor M₁ is approximately-V_{P}, the voltage V_{M2} across the memristor M₂ is approximately V_{P}, and the voltage V_{M3} across the memristor M₃ is approximately 0. The memristor M₂ maintains the high resistance state, and the memristor M₃ maintains the high resistance state, that is, the 1-bit addition result is sᵢ=0, cᵢ₊₁=0.

When input aᵢ=0, bᵢ=0, cᵢ=1, V=0, the memristor M₁ is set to the high resistance state, and the memristor M₂ is set to the low resistance state. In step 2, the voltage V_{M1} across the memristor M₁ is approximately 0, the voltage V_{M2} across the memristor M₂ is approximately 0, and the voltage V_{M3} across the memristor M₃ is approximately V_{P}. The memristor M₂ maintains the low resistance state, and the memristor M₃ maintains high resistance state. In step 3, the voltage V_{M1} across the memristor M₁ is approximately −2V_{P}, the voltage V_{M2} across the memristor M₂ is approximately V_{P}, and the voltage V_{M3} across the memristor M₃ is approximately 0. The memristor M₂ maintains the low resistance state, and the memristor M₃ maintains the high resistance state, that is, the 1-bit addition result is sᵢ=1, cᵢ₊₁=0.

When input aᵢ=0, bᵢ=1, cᵢ=0, V=V_{P}, the memristor M₁ is set to the high resistance state, and the memristor M₂ is set to the high resistance state. In step 2, the voltage V_{M1} across the memristor M₁ is approximately-V_{P}, the voltage V_{M2} across the memristor M₂ is approximately 0, and the voltage V_{M3} across the memristor M₃ is approximately V_{P}. The memristor M₂ maintains the high resistance state, and the memristor M₃ maintains the high resistance state. In step 3, the voltage V_{M1} across the memristor M₁ is approximately V_{P}, the voltage V_{M2} across the memristor M₂ is approximately 2V_{P}, and the voltage V_{M3} across the memristor M₃ is approximately 0. The memristor M₂ is converted to the low resistance state, the memristor M₃ maintains the high resistance state, that is, the 1-bit addition result is sᵢ=1, cᵢ₊₁=0.

When input aᵢ=0, bᵢ=1, cᵢ=1, V=V_{P}, the memristor M₁ is set to the high resistance state, and the memristor M₂ is set to the low resistance state. In step 2, the voltage V_{M1} across the memristor M₁ is approximately −V_{P}, the voltage V_{M2} across the memristor M₂ is approximately 0, and the voltage V_{M3} across the memristor M₃ is approximately V_{P}. The memristor M₂ maintains the low resistance state, and the memristor M₃ maintains the high resistance state. In step 3, the voltage V_{M1} across the memristor M₁ is approximately V_{P}, the voltage V_{M2} across the memristor M₂ is approximately 2V_{P}, and the voltage V_{M3} across the memristor M₃ is approximately 0. The memristor M₂ maintains the low resistance state, and the memristor M₃ maintains the high resistance state, that is, the 1-bit addition result is sᵢ=1, cᵢ₊₁=0.

When input aᵢ=1, bᵢ=0, cᵢ=0, V=0, the memristor M₁ is set to the low resistance state, and the memristor M₂ is set to the high resistance state. In step 2, the voltage V_{M1} across the memristor M₁ is approximately 0, the voltage V_{M2} across the memristor M₂ is approximately 0, and the voltage V_{M3} across the memristor M₃ is approximately V_{P}. The memristor M₂ maintains the high resistance state, and the memristor M₃ maintains the high resistance state. In step 3, the voltage V_{M1} across the memristor M₁ is approximately-V_{P}, the voltage V_{M2} across the memristor M₂ is approximately 2V_{P}, and the voltage V_{M3} across the memristor M₃ is approximately 0. The memristor M₂ is converted to the low resistance state, and the memristor M₃ maintains the high resistance state, that is, the 1-bit addition result is sᵢ=1, cᵢ₊₁=0.

When input aᵢ=1, bᵢ=0, cᵢ=1, V=0, the memristor M₁ is set to the low resistance state, and the memristor M₂ is set to the high resistance state. In step 2, the voltage V_{M1} across the memristor M₁ is approximately 0, the voltage V_{M2} across the memristor M₂ is approximately 0, and the voltage V_{M3} across the memristor M₃ is approximately V_{P}. The memristor M₂ maintains the low resistance state, and the memristor M₃ maintains the high resistance state. In step 3, the voltage V_{M1} across the memristor M₁ is approximately-V_{P}, the voltage V_{M2} across the memristor M₂ is approximately 2V_{P}, and the voltage V_{M3} across the memristor M₃ is approximately 0. The memristor M₂ maintains the low resistance state, and the memristor M₃ maintains the high resistance state, that is, the 1-bit addition result is sᵢ=1, cᵢ₊₁=0.

When input aᵢ=1, bᵢ=1, cᵢ=1, V=0, the memristor M₁ is set to the low resistance state, and the memristor M₂ is set to the high resistance state. In step 2, the voltage V_{M1} across the memristor M₁ is approximately-V_{P}, the voltage V_{M2} across the memristor M₂ is approximately 0, and the voltage V_{M3} across the memristor M₃ is approximately 2V_{P}. The memristor M₂ maintains the high resistance state, and the memristor M₃ is converted to the low resistance state. In step 3, the voltage V_{M1} across the memristor M₁ is approximately V_{P}, the voltage V_{M2} across the memristor M₂ is approximately V_{P}, and the voltage V_{M3} across the memristor M₃ is approximately 0. The memristor M₂ maintains the high resistance state, and the memristor M₃ maintains the low resistance state, that is, the 1-bit addition result is sᵢ=0, cᵢ₊₁=1.

When input aᵢ=1, bᵢ=1, cᵢ=1, V=V_{P}, the memristor M₁ is set to the low resistance state, and the memristor M₂ is set to the low resistance state. In step 2, the voltage V_{M1} across the memristor M₁ is approximately-V_{P}, the voltage V_{M2} across the memristor M₂ is approximately 0, and the voltage V_{M3} across the memristor M₃ is approximately 2V_{P}. The memristor M₂ maintains the low resistance state, and the memristor M₃ is converted to the low resistance state. In step 3, the voltage V_{M1} across the memristor M₁ is approximately V_{P}, the voltage V_{M2} across the memristor M₂ is approximately V_{P}, and the voltage V_{M3} across the memristor M₃ is approximately 0. The memristor M₂ maintains the low resistance state, and the memristor M₃ maintains the low resistance state, that is, the 1-bit addition result is sᵢ=1, cᵢ₊₁=1.

Based on the above operations, the 1-bit approximate adder operation method provided by the present embodiment may effectively control the logic output according to the operation truth table of the 1-bit approximate adder as shown in Table 2; wherein, cᵢ₊₁=aᵢ·bᵢ, sᵢ=aᵢ⊕bᵢ+cᵢ.

TABLE 2

| | | | Exact addition | | Approximate addition | |
|---|---|---|---|---|---|---|
| aᵢ | bᵢ | cᵢ | sᵢ | cᵢ₊₁ | sᵢ | cᵢ₊₁ |
| 0 | 0 | 0 | 0 | 0 | 0 | 0 |
| 0 | 0 | 1 | 1 | 0 | 1 | 0 |
| 0 | 1 | 0 | 1 | 0 | 1 | 0 |
| 0 | 1 | 1 | 0 | 1 | 1 | 0 |
| 1 | 0 | 0 | 1 | 0 | 1 | 0 |
| 1 | 0 | 1 | 0 | 1 | 1 | 0 |
| 1 | 1 | 0 | 0 | 1 | 0 | 1 |
| 1 | 1 | 1 | 1 | 1 | 1 | 1 |

In summary, the present embodiment performs operations on the approximate adder composed of memristors and fixed-value resistors, and may implement the 1-bit approximate adder circuit operation through three steps by setting states of the memristors and configuring different operation voltages at the control terminals. The present disclosure has the features of few device quantities, simple operation steps, and compact structure, thus providing reliable support for implementation of complex logic operations. Specifically, the present embodiment discloses the 1-bit approximate adder device based on memristor, including three completely identical memristors and one fixed-value resistor, and may implement approximate adder logic functions through three steps by setting states of the memristors and configuring three control terminals (BL₁, BL₂, BL₃) and the source line (SL) of the circuit. The positive electrodes of the memristor M₁, the memristor M₂ and the memristor M₃ are connected to different bit lines (BL₁, BL₂, BL₃), the negative electrodes of the memristor M₁, the memristor M₂ and the memristor M₃ are connected to the same source line SL. One end of the fixed-value resistor is connected to the control terminal of the source line SL, and the other end is connected to the negative electrode of the memristor closest to the source line control terminal. In logic calculation, one input logic value aᵢ is defined as the resistance state of the memristor M₁, another input logic value bᵢ is defined in the form of voltage at the control terminals BL₁ and SL. The input logic value cᵢ is defined as the resistance state of the memristor M₂, and the resistance states of the memristor M₂ and the memristor M₃ serve as outputs. While improving computational efficiency, circuit area is effectively saved, which helps support implementation of more complex logic functions.

### Embodiment 2

In the present embodiment, n is an integer greater than 1, and an n-bit approximate adder device for implementing approximate addition of two n-bit numbers aₙ . . . a₂a₁ and bₙ . . . b₂b₁ is provided, thereby obtaining a sum result sₙ . . . s₂s₁ and a carry output cₙ₊₁, as shown in FIG. 2, including: an approximate adder circuit and a control module. The approximate adder circuit includes: 2n+1 completely identical memristors and one resistor (a fixed-value resistor is adopted in the present embodiment). The control module includes: a controller 1 and a controller 2.

Similarly, in the present embodiment, the memristors include a high resistance state and a low resistance state. The high resistance state corresponds to a logic value “0”, and the low resistance state corresponds to a logic value “1”. The resistance value of the resistor is between the high resistance state resistance value and the low resistance state resistance value of the memristor, preferably R=\sqrt{R_{H}·R_{L}}, wherein R_{H} is the high resistance state resistance value of the memristor, and R_{L} is the low resistance state resistance value of the memristor.

Specifically, the controller 1 is respectively connected to positive electrodes of respective memristors. Negative electrodes of all memristors are connected to the same source line SL. One end of the source line SL is floating, and the other end is connected to the controller 2. The resistor is connected to the source line SL, with one end connected to a control terminal of the source line SL, and the other end connected to the negative electrode of the memristor closest to a source line control terminal.

The controller 1 is configured to divide an n-bit approximate addition process into initialization and n rounds of approximate addition sub-processes. Each round of the approximate addition sub-process executes the 1-bit approximate addition operation; specifically executing the following operations:

Initialization: selecting n memristors from the 2n+1 memristors, respectively writing logic values a₁~aₙ; selecting one memristor from the remaining memristors, writing an input carry c₁, and all other unset memristors are set to the high resistance state. For ease of operation, the present embodiment writes addend a₁~aₙ into the first n memristors, writes the input carry c₁ into the (n+1)th memristor, and simultaneously initializes the remaining n memristors to writing high resistance state. The input carry c₁ may be 0 or may be 1; in the present embodiment, c₁=0.

First round of the approximate addition sub-process: the memristor storing a₁ among the first n memristors is used as a first memristor, the (n+1)th memristor storing c₁ is used as a second memristor, and selecting the (n+2)th unset memristor as a third memristor. The operation of performing the 1-bit approximate addition specifically includes the following. In a first time period, a voltage V_{BL1_1}=−V is applied to the positive electrode of the first memristor, and the positive electrode of the second memristor is set to float. A voltage V_{BL3_1}=V_{P} is applied to the positive electrode of the third memristor. A voltage V_{SL_1} with an amplitude 0 is applied to the other end of the resistor. Under the circumstances, a carry c₂=a₁·b₁ is obtained from the third memristor. In a second time period after the first time period, a voltage V_{BL1_2}=V−V_{P} is applied to the positive electrode of the first memristor. A voltage V_{BL2_2}=V_{P} is applied to the positive electrode of the second memristor, and the positive electrode of the third memristor is set to float. A voltage V_{SL_2}=−V is applied to the other end of the resistor. Under the circumstances, a sum result s₁=a₁⊕b₁+c₁ is obtained from the second memristor.

The i-th round of approximate addition sub-process: the memristor storing aᵢ among the first n memristors is used as the first memristor. The (n+i)th memristor storing cᵢ is used as the second memristor. The (n+i+1)th memristor for storing cᵢ₊₁ is used as the third memristor. In the operation of performing the 1-bit approximate addition, the specific implementations are the same as the first round of the approximate addition sub-process, which will not be elaborated here; i=1, 2, . . . , n.

After the n~1 round of the approximate addition sub-process operations is performed, the resistance state of the second memristor is the sum result sₙ . . . s₂s₁ of the approximate addition of the two n-bit numbers. After the n-th round of the approximate addition sub-process operation is performed, the resistance state of the third memristor is the carry output cₙ₊₁ of the approximate addition of two n-bit numbers; sₙ . . . s₂s₁ and cₙ₊₁ are the approximate addition result of the required n-bit numbers aₙ . . . a₂a₁ and bₙ . . . b₂b₁.

Same as in the Embodiment 1, when the logic value bᵢ is 0, the value of V is 0; when the logic value bᵢ is 1, the value of V is V_{P}; V_{P} satisfies Vₛₑₜ/2<V_{P}<Vₛₑₜ, and V_{P}<2|Vᵣₑₛₑₜ|; Vₛₑₜ is the threshold for the memristor to convert from the high resistance state to the low resistance state; Vᵣₑₛₑₜ is the threshold for the memristor to convert from the low resistance state to the high resistance state.

It should be noted that an n-bit serial approximate adder is obtained by extending the 1-bit approximate adder described in Embodiment 1, but the n-bit serial approximate adder is only an extension of a part of the memristor. The entire n-bit serial approximate adder includes only one resistor, the specific operating principle is the same as Embodiment 1, which will not be elaborated here. The actual operation steps required for the entire n-bit serial approximate adder are 2n+1 steps, the present scheme is not only compact in area and easy to extend, but also may maintain low circuit complexity and short delay after extension.

To make the technical scheme of the present embodiment clearer, specifically, a 4-bit serial approximate addition circuit is used as aₙ example, and the description is as follows:

As shown in FIG. 3, FIG. 3 shows the 4-bit serial approximate adder device provided by the present disclosure, which requires one resistor, 9 memristors and 9 steps to implement a 4-bit serial approximate addition, s₁=a₁⊕b₁+c₁, s₂=a₂⊕b₂+c₂, s₃=a₃⊕b₃+c₃, s₄=a₄⊕b₄+c₄, and c₅=a₄·b₄; wherein BL₁-BL₉ are respectively connected to memristors M₁-M₉. Based on the serial approximate adder circuit obtained by extension, the present disclosure also provides a control method for the 4-bit serial approximate adder circuit for implementing aₙ approximate addition of two 4-bit numbers a₄a₃a₂a₁ and b₄b₃b₂b₁, thereby obtaining a sum result s₄s₃s₂s₁ and a carry output c₅. Specifically, the above serial approximate addition method includes the following 9 actual operation steps.
Step 1. The addends a₁, a₂, a₃, and a₄ are written into the first 4 memristors M₁, M₂, M₃, and M₄ respectively, c₁ is written into the 5th memristor M₅, and the remaining 4 memristors are initialized to the high resistance state.
Step 2. The memristor M₁ storing a₁ is used as the first memristor. The memristor M₅ storing c₁ is used as the second memristor. In the meantime, the memristor M₆ is selected to store c₂ to be generated, and is used as the third memristor. V_{BL1_1}=−V is applied to the first memristor, so that the BL control terminal of the second memristor is floating. V_{BL3_1}=V_{P} is applied to the third memristor, and the value of the voltage V_{SL_1} is 0. After the operation is completed, the resistance value of the third memristor is the logic value of c₂=a₁·b₁.
Step 3. V_{BL1_2}=V−V_{P} is applied to the first memristor. V_{BL2_2}=V_{P} is applied to the second memristor, so that the BL control terminal of the third memristor is floating. The value of the voltage V_{SL_2} is −V. After the operation is completed, the resistance value of the second memristor is the logic value of s₁=a₁⊕b₁+c₁. When the logic value bᵢ is 0, the value of V is 0. When the logic value b is 1, the value of V is V_{P}.
Step 4. The memristor M₂ storing a₂ is used as the first memristor. The memristor M₆ storing c₂ is selected as the second memristor. In the meantime, the memristor M₇ is selected to store c₃ to be generated, and is used as the third memristor. V_{BL1_1}=−V is applied to the first memristor, so that the BL control terminal of the second memristor is floating. V_{BL3_1}=V_{P} is applied to the third memristor, and the value of the voltage V_{SL}_1 is 0. After the operation is completed, the resistance value of the third memristor is the logic value of c₃=a₂·b₂.
Step 5. V_{BL1_2}=V−V_{P} is applied to the first memristor. V_{BL2_2}=V_{P} is applied to the second memristor, so that the BL control terminal of the third memristor is floating. The value of the voltage V_{SL_2} is −V. After the operation is completed, the resistance value of the second memristor is the logic value of s₂=a₂⊕b₂+c₂. When the logic value b₂ is 0, the value of V is 0. When the logic value b₂ is 1, the value of V is V_{P}.
Step 6. The memristor M₃ storing a₃ is used as the first memristor. The memristor M₇ storing c₃ is used as the second memristor. In the meantime, the memristor M₈ is selected to store c₄ to be generated, and is used as the third memristor. V_{BL1_1}=−V is applied to the first memristor, so that the BL control terminal of the second memristor is floating. V_{BL3_1}=V_{P} is applied to the third memristor, and the value of the voltage V_{SL_1} is 0. After the operation is completed, the resistance value of the third memristor is the logic value of c₄=a₃·b₃.
Step 7. V_{BL1_2}=V−V_{P} is applied to the first memristor. V_{BL2_2}=V_{P} is applied to the second memristor. The BL control terminal of the third memristor is floating. The value of the voltage V_{SL_2} is −V. After the operation is completed, the resistance value of the second memristor is the logic value of s₃=a₃⊕b₃+c₃. When the logic value b₃ is 0, the value of V is 0. When the logic value b₃ is 1, the value of V is V_{P}.
Step 8. The memristor M₄ storing a₄ is used as the first memristor. The memristor M₈ storing c₄ is selected as the second memristor. In the meantime, the memristor M₉ is selected to store c₄ to be generated, and is used as the third memristor. V_{BL1_1}=−V is applied to the first memristor, so that the BL control terminal of the second memristor is floating. V_{BL3_1}=V_{P} is applied to the third memristor, and the value of voltage V_{SL_1} is 0. After the operation is completed, the resistance value of the third memristor is the logic value of c₅=a₄·b₄.
Step 9. V_{BL1_2}=V−V_{P} is applied to the first memristor. V_{BL2_2}=V_{P} is applied to the second memristor. The BL control terminal of the third memristor is floating. The value of the voltage V_{SL_2} is −V. After the operation is completed, the resistance value of the second memristor is the logic value of s₄=a₄⊕b₄+c₄. When the logic value b₄ is 0, the value of V is 0. When the logic value b₄ is 1, the value of V is V_{P}.

It should be noted that in the above step 2-step 3, step 4-step 5, step 6-step 7 and step 8-step 9, these four entireties are all similar approximate addition sub-processes, the difference lies in three different memristors are selected to perform approximate addition calculation of different bits.

It should be further noted that other circuit structures and operation processes of n-bit approximate adders based on the present disclosure are similar to the 4-bit serial approximate adder logic operation process, which will not be elaborated here.

Those skilled in the art can easily understand that the above descriptions are only preferred embodiments of the present disclosure and are not intended to limit the present disclosure. Any modifications, equivalent substitutions and improvements made within the spirit and principles of the present disclosure should be included within the scope to be protected by the present disclosure.

What is claimed is:

1. A control method for an approximate adder circuit based on memristor, for implementing an approximate addition of n-bit numbers aₙ . . . a₂a₁ and bₙ . . . b₂b₁; the approximate adder circuit comprising: a resistor and 2n+1 identical memristors; negative electrodes of the respective memristors are all connected to a same source line SL; one end of the source line SL is floating, and the other end is connected to one end of the resistor; n≥1;
the control method comprising:
selecting n memristors from the 2n+1 memristors, and writing logic values a₁~aₙ respectively; selecting one memristor from the remaining memristors, and writing aₙ input carry c₁; setting all other unset memristors to a high resistance state;
executing n rounds of approximate addition sub-processes sequentially, wherein, in aₙ i-th round of the approximate addition sub-process, the following operations are executed:
in a first time period, a memristor written with a logic value aᵢ is used as a first memristor, and a voltage −V is applied to a positive electrode thereof, a memristor storing the carry cᵢ is used as a second memristor, and a positive electrode thereof is set to float, one memristor among the unset memristors is selected as a third memristor, a voltage V_{P} is applied to a positive electrode thereof, and a voltage with aₙ amplitude 0 is applied to the other end of the resistor, under the circumstances, carry cᵢ₊₁=aᵢ·bᵢ is obtained from the third memristor;
in a second time period after the first time period, a voltage V−V_{P} is applied to the positive electrode of the first memristor, the voltage V_{P} is applied to the positive electrode of the second memristor, the positive electrode of the third memristor is set to float, the voltage −V is applied to the other end of the resistor, under the circumstances, a sum result sᵢ=aᵢ⊕bᵢ+cᵢ is obtained from the second memristor;
wherein, i=1, 2, . . . , n, when a logic value bᵢ is 0, a value of V is 0; when the logic value bᵢ is 1, a value of V is V_{P}; V_{P} satisfies Vₛₑₜ/2<V_{P}<Vₛₑₜ, and V_{P}<2|Vᵣₑₛₑₜ|; Vₛₑₜ is a threshold for the memristor to convert from the high resistance state to a low resistance state; Vᵣₑₛₑₜ is a threshold for the memristor to convert from the low resistance state to the high resistance state;
sₙ . . . s₂s₁ and cₙ₊₁ are an approximate addition result of the required n-bit numbers aₙ . . . a₂a₁ and bₙ . . . b₂b₁.

2. An approximate adder device, for implementing an approximate addition of n-bit numbers aₙ . . . a₂a₁ and bₙ . . . b₂b₁, comprising: an approximate adder circuit and a control module;
the approximate adder circuit comprising: a resistor and 2n+1 identical memristors, negative electrodes of respective memristors are all connected to a same source line SL, one end of the source line SL is floating, and the other end is connected to one end of the resistor; n≥1;
wherein the control module is configured to execute the control method according to claim 1.

3. The approximate adder device according to claim 2, wherein a resistance value of the resistor is between a high resistance state resistance value and a low resistance state resistance value of the memristor.

4. The approximate adder device according to claim 3, wherein the resistance value of the resistor is R=\sqrt{R_{H}·R_{L}}, wherein, R_{H} is the high resistance state resistance value of the memristor, R_{L} is the low resistance state resistance value of the memristor.

5. The approximate adder device according to claim 2, wherein each of the memristors comprises the high resistance state and the low resistance state, the high resistance state corresponds to a logic value “0”, and the low resistance state corresponds to a logic value “1”.

6. A control system, comprising: a memory and a processor, wherein the memory stores a computer program, and the processor executes the control method according to claim 1 when executing the computer program.

7. A computer-readable storage medium, comprising a stored computer program, wherein when the computer program is run by a processor, the computer program controls a device where the storage medium is located to execute the control method according to claim 1.

8. A computer program product, comprising a computer program/instruction, and when the computer program/instruction is executed by a processor, the control method according to claim 1 is implemented.
